(19) United States
(12) Patent Application Publication
(10) Pub. No.: US 2010/0325552 A1
(43) Pub. Date: Dec. 23, 2010

(54) Media Asset Navigation Representations

(76) Inventors: David H. Sloo, Menlo Park, CA (US); Ronald A. Morris, Seattle, WA (US)

Correspondence Address: MICROSOFT CORPORATION, ONE MICROSOFT WAY, REDMOND, WA, 98052, US

(21) Appl. No.: 12/488,216

(22) Filed: Jun. 19, 2009

(51) Int. Cl. G06F 3/00

(52) U.S. Cl. 715/738

(57) ABSTRACT

Media asset navigation representations are described. In various embodiments, a content navigation input is received, such as an input to a client device, to initiate a display of a media asset navigation interface from which media assets can be selected. Groups of related media assets are determined, and each group of related media assets is represented for user selection from the media asset navigation interface. A visual element is identified for each group of related media assets, and the visual elements each provide a coherent visual representation of the related media assets in a respective group. A display can be initiated of the visual elements in the media asset navigation interface where each of the visual elements are selectable to individually navigate the related media assets in the respective groups.

### BACKGROUND

Portable devices are increasingly more common and mobile, such as laptop computers, tablet personal computers (PCs), mobile PCs, as well as other mobile data, messaging, and/or communication devices. While portable devices have become more mobile and convenient, the size of device integrated displays has decreased to accommodate the mobility and convenience of the devices. Current visual browsers for videos, photos, and game content rely on the ability of a user to recognize particular media assets in order to select or make decisions based on those media assets. This limits the display size of the media assets because a user needs to see enough of an image to discern a media asset for selection. As the display screens become smaller, pictorial details can be lost. Even with images of media assets displayed on a larger display, only certain static or moving visual images are easily recognizable.

### SUMMARY

This summary is provided to introduce simplified concepts of media asset navigation representations. The simplified concepts are further described below in the Detailed Description. This summary is not intended to identify essential features of the claimed subject matter, nor is it intended for use in determining the scope of the claimed subject matter.

Media asset navigation representations are described. In various embodiments, a content navigation input is received, such as an input to a client device, to initiate a display of a media asset navigation interface from which media assets can be selected. Groups of related media assets are determined, and each group of related media assets is represented for user selection from the media asset navigation interface. A visual element is identified for each group of related media assets, and the visual elements each provide a coherent visual representation of the related media assets in a respective group. A display can be initiated of the visual elements in the media asset navigation interface where each of the visual elements are selectable to individually navigate the related media assets in the respective groups.

In other embodiments, the related media assets of a group can be related by a genre of the related media assets in the group, a visual feature that is common to the related media assets in the group, or an archetype that correlates to the related media assets in the group. The related media assets can include, but are not limited to, live television programs, recorded videos, music files, photographs, and/or documents. The visual element for a group of related media assets can be determined as the visual element that is most likely discernable by a user as a coherent visual representation of the group of related media assets.

A visual element for a group of related media assets can be an image that corresponds to one of the related media assets, or a composite image that corresponds to more than one of the related media assets. A visual element for a group of related media assets can also be displayed on a media asset navigation interface as a video, an image, a logo, or any other non-textual representation of the related media assets. Additionally, the visual element for the group of related media assets changes for resolution degradation, such as from the video to the image and then from the image to the logo, as content navigation inputs are received that broaden the coherent visual representation of the related media assets.

### BRIEF DESCRIPTION OF THE DRAWINGS

Embodiments of media asset navigation representations are described with reference to the following drawings. The same numbers are used throughout the drawings to reference like features and components:

FIG. 1 illustrates an example system in which embodiments of media asset navigation representations can be implemented.

FIG. 2 illustrates example media asset navigation interfaces in accordance with one or more embodiments.

FIG. 3 illustrates example method(s) for media asset navigation representations in accordance with one or more embodiments.

FIG. 4 illustrates various components of an example device that can implement embodiments of media asset navigation representations.

### DETAILED DESCRIPTION

Embodiments of media asset navigation representations provide that media assets, such as live television programs, recorded videos, music files, photographs, and documents, can be related into groups. The groups of media assets can be related based on various relatable factors, such as metadata, similarity of content, a genre, a visual feature that is common to the media assets, or an archetype that correlates the media assets in the group. A visual element can then be displayed to represent a group of related media assets where the visual element is a coherent visual representation of the related media assets that is most likely discernable by a user. The visual element that represents a group of media assets can be determined by the level of hierarchy currently being viewed, rather than by the adjacent media assets and the context. A user can then navigate the relationships of the media assets, rather than simply traversing lists of media assets when searching for viewing choices, song selections, photo viewing, and the like.

While features and concepts of the described systems and methods for media asset navigation representations can be implemented in any number of different environments, systems, and/or various configurations, embodiments of media asset navigation representations are described in the context of the following example systems and environments.

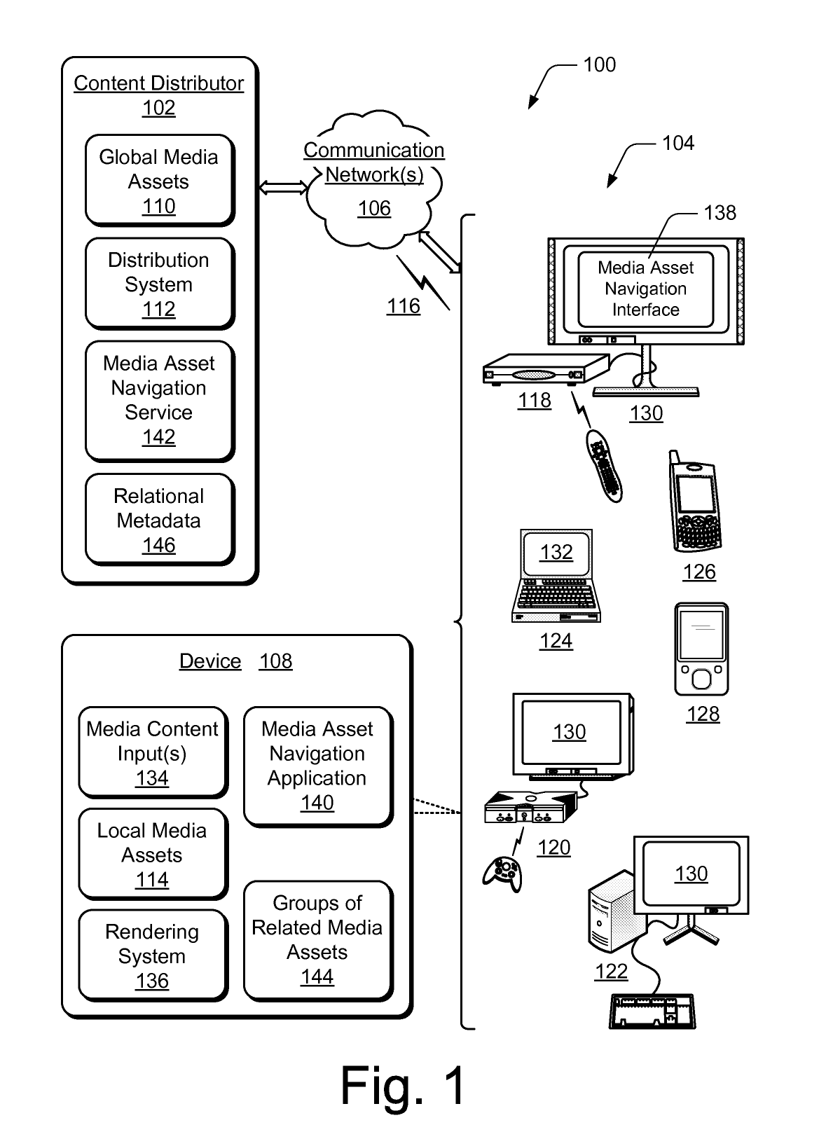

FIG. 1 illustrates an example system 100 in which various embodiments of media asset navigation representations can be implemented. System 100 includes a content distributor 102 implemented for media content distribution and communication with various client devices 104 via communication networks 106. An example device 108 is representative of various client devices 104 that receive media assets 110 when distributed from content distributor 102. In a media content distribution system, the content distributor 102 can be implemented as one or more server devices that include a distribution system 112 to facilitate distribution of the media assets 110, metadata, and other associated data to multiple viewers, users, customers, subscribers, viewing systems, consumer devices, and the various client devices 104.

Media content (e.g., to include recorded media content) includes media assets and any type of audio, video, and/or image data received from any media content and/or data source. In various implementations, media assets include both global media assets 110 that are maintained at the content distributor 102 and available to any of the various client devices 104, and include local media assets 114 that are maintained local to a device, such as the local media assets 114 stored on device 108. As described herein, a media asset can include recorded video content, video-on-demand content, television content, television programs (or live programming), advertisements, commercials, music files, movies, video clips, digital photographs, documents and other types of media assets. Other media content can include interactive games, network-based applications, and any other content, assets, or data (e.g., to include user interface data, advertising content, closed captions data, content metadata, search results and/or recommendations, etc.).

The communication networks 106 include any type of a data network, voice network, broadcast network, an IP-based network, and/or a wireless network 116 that facilitates communication of data and media content in any format. The communication networks 106 can be implemented using any type of network topology and/or communication protocol, and may be represented or otherwise implemented as a combination of two or more networks. In addition, any one or more of the arrowed communication links facilitate two-way data communication.

The various client devices 104 in system 100 can be implemented as any one or combination of a wired and/or wireless device, as any form of television client device 118 (e.g., television set-top box, digital video recorder (DVR), etc.), gaming device 120, computer device 122, portable computer 124, consumer device, media device, communication and/or messaging device, video processing and/or rendering device, appliance device, electronic device, and/or as any other type of device that is implemented to receive media content in any form of audio, video, and/or image data. A client device 104 may also be implemented as any type of mobile phone 126 (e.g., cellular, VoIP, WiFi, etc.), a portable media device 128 (e.g., a personal media player, portable media player, handheld media player, etc.), or any other wired and/or wireless device.

The various client devices 104 shown in system 100 can be implemented as components in client systems that include a respective display device 130, or as a client device that includes an integrated display 132. A display device 130 can be implemented as any type of a television, high definition television (HDTV), LCD, or similar display system. The various client devices 104 can also be associated with one or more input devices, such as a remote control device for user-selectable inputs and selections to the television client device 118, a gaming controller for user-selectable inputs to the gaming device 120, a keyboard and mouse input devices for user-selectable inputs to the computer device 122 and portable computer 124, an alphanumeric keypad for user-selectable inputs to the mobile phone 126, and various user-selectable inputs to the portable media device 128. Other input devices for user-selectable inputs and selections to the various devices can include a two-input controller, a two-dimensional or three-dimensional controller, a pointing device, a touch controller, and a gestural controller that can all be utilized for the various embodiments of media asset navigation representations as described herein.

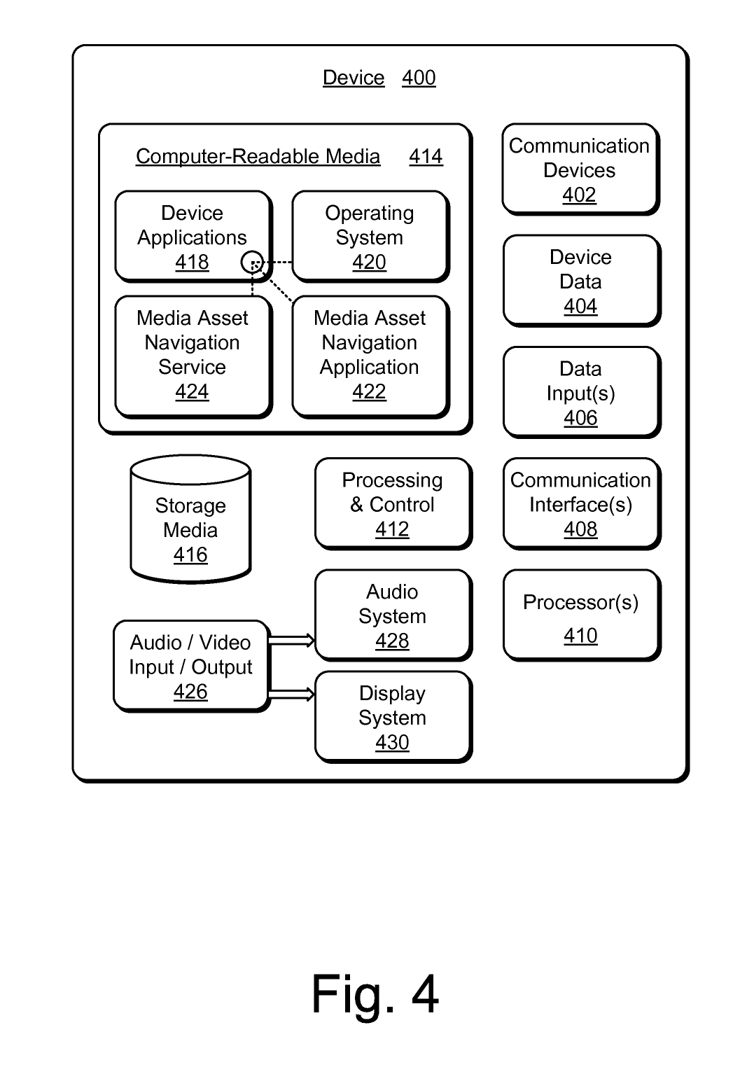

Any of the devices described herein can be implemented with any number and combination of differing components as described with reference to the example device shown in FIG. 4, such as one or more processors, communication components, data inputs, memory components, processing and control circuits, and/or a media content rendering system. The example device 108 is representative of the various client devices 104 that implement various embodiments of media asset navigation representations.

In this example, device 108 includes media content inputs 134 to receive media assets 110 from content distributor 102. The media content inputs 134 can include any type of communication interfaces and/or data inputs, such as Internet Protocol (IP) inputs over which streams of media content (e.g., IPTV content) are received via an IP-based network. An IPTV receiver can include a media content input 134 to receive television content as an IPTV multicast via an Ethernet input port from content distributor 102. In addition, the media content inputs 134 include any type of broadcast and/or over-the-air inputs via which media content is received over the air.

Device 108 can also include one or more tuners to tune television channels and/or data streams for display and viewing, such as when device 108 is implemented as a television client device. In various implementations, a tuner can be implemented as a hardware tuner, or alternatively, as a software tuner that is implemented to tune to a television channel and/or data stream. Device 108 includes a rendering system 136 to receive and/or render media content in any form of audio, video, and/or image data received from any media content and/or data source. In various embodiments, the rendering system 136 is implemented to render a media asset navigation interface 138 for display, such as shown on the display device 130 that is associated with the television client device 118.

In this example system 100, device 108 includes a media asset navigation application 140 that can be implemented as computer-executable instructions and executed by processors to implement embodiments and/or features of media asset navigation representations. In embodiments, any of the various devices 104 can include the media asset navigation application 140 to independently implement media asset navigation representations. Alternatively or in addition, the content distributor 102 includes a media asset navigation service 142 that implements embodiments and/or features of media asset navigation representations, either independently, or in conjunction with a media asset navigation application at a client device 104.

In various embodiments, the media asset navigation application 140 at device 108 and/or the media asset navigation service 142 at content distributor 102 is implemented to determine groups of related media assets 144. A group of media assets can be related based on any relatable factor or factors, such as relational metadata 146, similarity of content, a genre that is common to the media assets in the group, a visual feature that is common to the media assets in the group, or an archetype that correlates the media assets in the group.

The relational metadata 146 can include any type of identifying criteria, descriptive information, and/or attributes associated with the global media assets 110 and the local media assets 114 that describes and/or categorizes the media assets. For example, metadata can include a media asset identifier, title, subject description, a date of production, artistic information, music compilations, and any other possible descriptive information about a particular media asset. Further, metadata can characterize a genre that describes a media asset, such as video content, as being an advertisement, a movie, a comedy show, a sporting event, a news program, a sitcom, a talk show, an action/adventure program, or as any number of other category descriptions.

A group of related media assets 144 may be related by a common visual feature, such as the media assets are cartoons, or sporting events that take place on a grass field. A common visual feature of the related media assets may be nature or landscape settings in movies that would otherwise be categorized in different genres, such as a western movie and a nature documentary. A group of related media assets 144 may also be related by an archetype that correlates the media assets, such as by the literary concept of a tragedy that would include many different movies that may otherwise be categorized in different genres, and would not be considered related. The global media assets 110 and/or the local media assets 114 can be related in a group based on various, relevant associations.

The media asset navigation application 140 and/or the media asset navigation service 142 can identify a visual element for each group of related media assets 144, where a visual element provides a coherent visual representation of the related media assets in a group. A visual element for a group of related media assets can be identified, selected, or otherwise determined as the visual element that is most likely discernable by a user as a coherent visual representation of the group of related media assets. For example, a group of media assets may all be related to sporting events that are currently being televised, such as a football game, a golf match, a poker game, a wrestling match, and a car race. The group of related media assets (e.g., all of the sporting events) can be represented on a media asset navigation interface by a single visual element that corresponds to the football game which is likely the more recognizable sport to a user.

A visual element for a group of related media assets can be a video, an image, a logo, or any other non-textual representation of the related media assets. The visual element for a group of related media assets can also correspond to one of the related media assets in the group, or can be a composite image or other non-textual representation that corresponds to more than one of the related media assets in the group. The visual element that represents a group of related media assets can be changed for resolution degradation from the video to the image and then from the image to the logo as content navigation inputs are received that broaden the coherent visual representation of the related media assets. When the media asset navigation service 142 at the content distributor 102 determines or identifies visual elements for groups of related media assets 144, the visual elements can be communicated to device 108 for display on the media asset navigation interface 138.

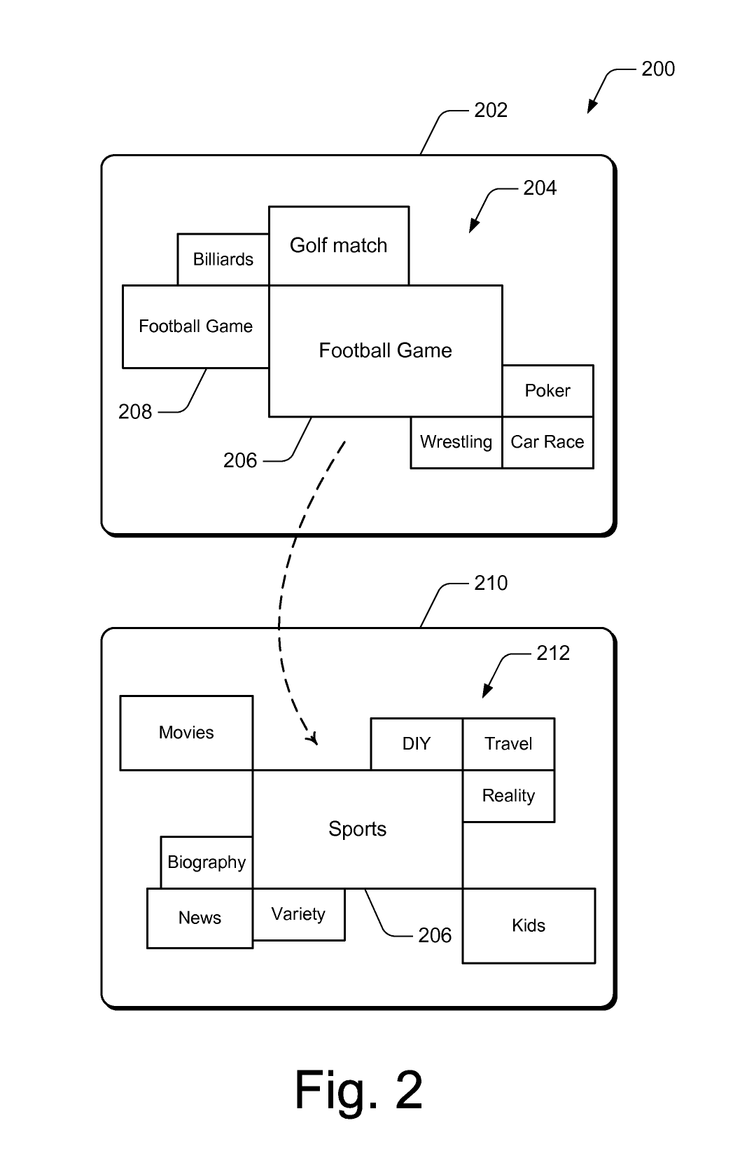

FIG. 2 illustrates various examples of media asset navigation interfaces 200 in embodiments of media asset navigation representations. A navigation interface 202 illustrates one example that includes a collection of visual elements 204 and each represents a different television program (e.g., media assets that are being televised in the sports genre). Although the visual elements 204 are shown in the navigation interface with text identifiers, the text identifiers are only included to signify the actual non-textual representations of the different television programs. In practice, a visual element 204 of a television program can be included in a media asset navigation interface as a video, picture-in-picture, image, photo, logo, or any other non-textual representation of a television program.

Additionally, the relative size of a visual element 204 shown in the media asset navigation interface 202 can indicate that a corresponding television program is likely a more or less popular viewing choice. For example, the visual element 206 that represents the football game is displayed larger than the other visual elements that represent the other sports programs to indicate that the football game at 206 is likely a more popular viewing choice. The media asset navigation interface 202 also includes another visual element 208 that represents an additional football game being televised as a sports program. The visual element 206 can be displayed larger than the visual element 208 to indicate that the football game represented by visual element 206 is the last program that was displayed for viewing (e.g., a user was last watching the football game represented by visual element 206).

The media asset navigation application 140 at device 108 can receive a navigation input, such as a user-initiated input to television client device 118 with the remote control device. The navigation input can be received to broaden the visual representation of media assets that are available for selection and viewing. A navigation interface 210 illustrates another example of a media asset navigation interface in which visual elements 212 are displayed that represent groups of related media assets. As noted above, although the visual elements 212 are shown in the navigation interface with text identifiers, the text identifiers are only included to signify the actual non-textual representations of the groups of related media assets. In practice, a visual element 212 can be included in the navigation interface as a video, picture-in-picture, image, photo, logo, or any other non-textual representation of the media assets.

The same visual element 206 that represents the football game in the media asset navigation interface 202 is the visual element that represents all of the sporting events in the media asset navigation interface 210. The single visual element that corresponds to the football game is likely the more recognizable sport to a user, and represents the sports genre in general including all of the visual elements 204 shown in the media asset navigation interface 202. The visual element 206 is also displayed larger than the other visual elements 212 in the media asset navigation interface 210 to indicate that the football game is the most recently viewed or selected program by the user.

Other criteria can be utilized to determine the visual element 206 that represents the group of related sports programs in the media asset navigation interface 210. For example, a visual element can be identified or otherwise determined from a pronounced visual difference from the other representative images. For example, the media asset navigation application and/or service can be implemented to identify or select a broad swath of green grass as shown often in a football game or golf match, and utilize this visual element to represent all of the sporting events.

Other visual element selection criteria can include the popularity or iconic quality of a program or element within a group of related media assets. The selection criteria can also include the relevance of a visual element to the current discovery context. For example, the collection of programs that can be selected for viewing on a particular channel can be represented by video, or a still image of the video, of the program that is currently being aired for viewing. The selection criteria can also include traditional search relevance of a particular image in a group of related media assets. For example, if a visual element represents a video that is commonly referred to or is popular in some context, such as discussion groups, then the visual element may be the likely choice to represent the group of related media assets.

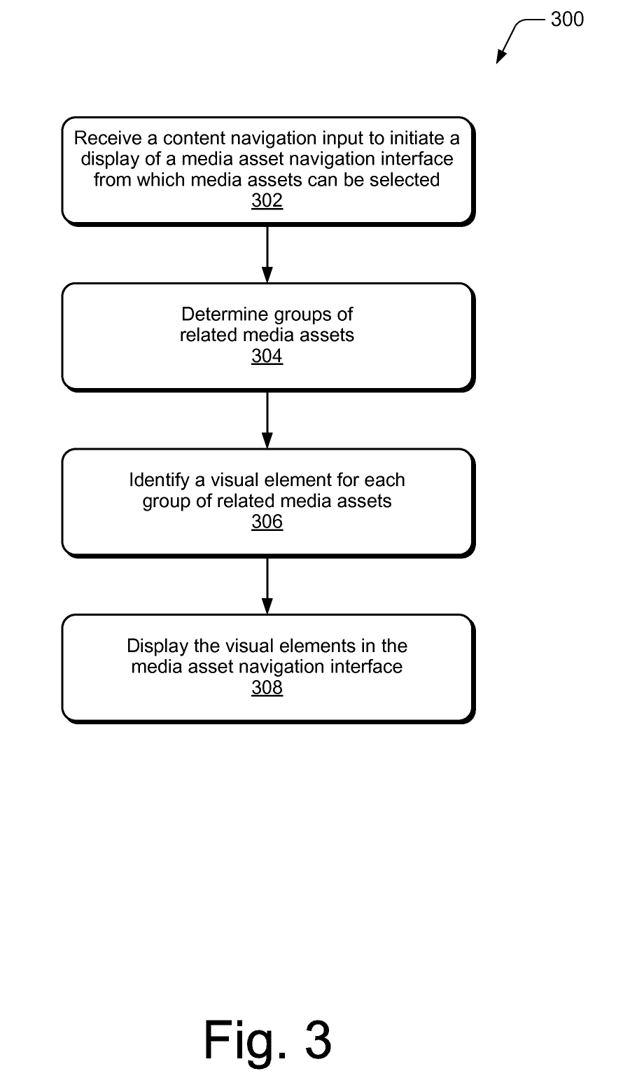

Example method 300 is described with reference to FIG. 3 in accordance with one or more embodiments of media asset navigation representations. Generally, any of the functions, methods, procedures, components, and modules described herein can be implemented using hardware, software, firmware, fixed logic circuitry, manual processing, or any combination thereof. A software implementation of a function, method, procedure, component, or module represents program code that performs specified tasks when executed on a computing-based processor. The example methods may be described in the general context of computer-executable instructions, which can include software, applications, routines, programs, objects, components, data structures, procedures, modules, functions, and the like.

The methods may also be practiced in a distributed computing environment where functions are performed by remote processing devices that are linked through a communication network. In a distributed computing environment, computer-executable instructions may be located in both local and remote computer storage media, including memory storage devices. Further, the features described herein are platform-independent such that the techniques may be implemented on a variety of computing platforms having a variety of processors.

FIG. 3 illustrates example method(s) 300 for media asset navigation representations. The order in which the method is described is not intended to be construed as a limitation, and any number of the described method blocks can be combined in any order to implement the method, or an alternate method.

At block 302, a content navigation input is received to initiate a display of a media asset navigation interface from which media assets can be selected. For example, the media asset navigation application 140 at device 108 receives a content navigation input, such as from a user via an input device, to initiate a display of a media asset navigation interface from which media assets can be selected. The media assets include the global media assets 110 maintained at the content distributor 102 and the local media assets 114 maintained at the client device 108. The media assets can include, but are not limited to, live television programs, recorded videos, music files, photographs, and/or documents.

At block 304, groups of related media assets are determined. For example, the media asset navigation application 140 at device 108 relates media assets into groups based on any relatable factor or factors, such as relational metadata 146, similarity of content, a genre that is common to the media assets in the group, a visual feature that is common to the media assets in the group, or an archetype that correlates the media assets in the group. Each group of related media assets can be represented with visual elements 212 for user selection from the media asset navigation interface 210.

At block 306, a visual element for each group of related media assets is identified. For example, the media asset navigation application 140 at device 108 identifies a visual element for each group of related media assets 144, where a visual element provides a coherent visual representation of the related media assets in a group. A visual element for a group of related media assets can be identified, selected, or otherwise determined as the visual element that is most likely discernable by a user as a coherent visual representation of the group of related media assets. The media asset navigation service 142 at content distributor 102 can optionally determine the groups of related media assets (at block 304) and identify a visual element for each group of related media assets (at block 306), and then communicate the groups of related media assets 144 and visual elements to device 108.

At block 308, the visual elements are displayed in the media asset navigation interface. For example, the visual elements 212 that represent the groups of related media assets are displayed in the media asset navigation interface 210 as any one of a video, an image, a logo, or any other non-textual representation of the related media assets. Each of the visual elements 212 are selectable from the navigation interface to individually navigate the related media assets in the respective groups.

FIG. 4 illustrates various components of an example device 400 that can be implemented as any type of client device and/or content distributor as described with reference to FIG. 1 to implement embodiments of media asset navigation representations. In various embodiments, device 400 can be implemented as any one or combination of a wired and/or wireless device, as any form of television client device (e.g., television set-top box, digital video recorder (DVR), etc.), consumer device, computer device, portable computer device, media device, communication device, video processing and/or rendering device, appliance device, gaming device, electronic device, and/or as any other type of device. Device 400 may also be associated with a user (i.e., a person) and/or an entity that operates the device such that a device describes logical devices that include users, software, firmware, and/or a combination of devices.

Device 400 includes communication devices 402 that enable wired and/or wireless communication of device data 404 (e.g., received data, data that is being received, data scheduled for broadcast, data packets of the data, etc.). The device data 404 or other device content can include configuration settings of the device, media content stored on the device, and/or information associated with a user of the device. Media content stored on device 400 can include media assets and any type of audio, video, and/or image data. Device 400 includes one or more data inputs 406 via which any type of data, media content, and/or inputs can be received, such as user-selectable inputs, music, television media content, recorded video content, and any other type of audio, video, and/or image data received from a content or data source.

Device 400 also includes communication interfaces 408 that can be implemented as any one or more of a serial and/or parallel interface, a wireless interface, any type of network interface, a modem, and as any other type of communication interface. The communication interfaces 408 provide a connection and/or communication links between device 400 and a communication network by which other electronic, computing, and communication devices communicate data with device 400.

Device 400 includes one or more processors 410 (e.g., any of microprocessors, controllers, and the like) which process various computer-executable instructions to control the operation of device 400 and to implement embodiments of media asset navigation representations. Alternatively or in addition, device 400 can be implemented with any one or combination of hardware, firmware, or fixed logic circuitry that is implemented in connection with processing and control circuits which are generally identified at 412. Although not shown, device 400 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 400 also includes computer-readable media 414, such as one or more memory components, examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Device 400 can also include a mass storage media device 416.

Computer-readable media 414 provides data storage mechanisms to store the device data 404, as well as various device applications 418 and any other types of information and/or data related to operational aspects of device 400. For example, an operating system 420 can be maintained as a computer application with the computer-readable media 414 and executed on processors 410. The device applications 418 can include a device manager (e.g., a control application, software application, signal processing and control module, code that is native to a particular device, a hardware abstraction layer for a particular device, etc.). The device applications 418 also include any system components or modules to implement embodiments of media asset navigation representations, such as a media asset navigation application 422 (e.g., when device 400 is implemented as a client device) and/or a media asset navigation service 424 (e.g., when device 400 is implemented as a server device or content distributor). In this example, the device applications 418 are shown as software modules and/or computer applications. Alternatively or in addition, the media asset navigation application 422 and the media asset navigation service 424 can be implemented as hardware, software, firmware, or any combination thereof.

Device 400 can also include an audio and/or video input-output system 426 that provides audio data to an audio system 428 and/or provides video data to a display system 430. The audio system 428 and/or the display system 430 can include any devices that process, display, and/or otherwise render audio, video, and image data. Video signals and audio signals can be communicated from device 400 to an audio device and/or to a display device via an RF (radio frequency) link, S-video link, composite video link, component video link, DVI (digital video interface), analog audio connection, or other similar communication link. In an embodiment, the audio system 428 and/or the display system 430 are implemented as external components to device 400. Alternatively, the audio system 428 and/or the display system 430 are implemented as integrated components of example device 400.

Although embodiments of media asset navigation representations have been described in language specific to features and/or methods, it is to be understood that the subject of the appended claims is not necessarily limited to the specific features or methods described. Rather, the specific features and methods are disclosed as example implementations of media asset navigation representations.

1. A method implemented by a device that executes a media asset navigation application, the method comprising:
receiving a content navigation input to initiate a display of a media asset navigation interface from which media assets can be selected;
determining one or more groups of related media assets, each group of related media assets being represented for user selection from the media asset navigation interface;
identifying a visual element for each group of related media assets, the visual elements each providing a coherent visual representation of the related media assets in a respective group; and
initiating a display of the visual elements in the media asset navigation interface, each of the visual elements being selectable to individually navigate the related media assets in the respective groups.

2. A method as recited in claim 1, wherein the related media assets of a group are related by at least one of:
a genre of the related media assets in the group;
a visual feature that is common to the related media assets in the group; or an archetype that correlates to the related media assets in the group.

3. A method as recited in claim 1, wherein the visual element for a group of related media assets is at least one of an image that corresponds to one of the related media assets, or a composite image that corresponds to more than one of the related media assets.

4. A method as recited in claim 1, wherein the visual element for a group of related media assets is at least one of a video, an image, a logo, or a non-textual representation of the related media assets.

5. A method as recited in claim 4, wherein the visual element for the group of related media assets changes for resolution degradation from the video to the image and then from the image to the logo as additional content navigation inputs are received that broaden the coherent visual representation of the related media assets.

6. A method as recited in claim 1, wherein identifying the visual element for a group of related media assets includes determining the visual element that is most likely discernable by a user as the coherent visual representation of the group of related media assets.

7. A method as recited in claim 1, wherein the media assets include at least one of live television programs, recorded videos, music files, photographs, or documents.

8. A method as recited in claim 1, further comprising communicating between the device and a media asset navigation service that said determines the one or more groups of related media assets, and said identifies the visual element for each group of related media assets.

9. A media asset navigation system, comprising:
a server device that includes at least a memory and a processor to implement a media asset navigation service that is configured to:
receive a content navigation input from a client device for a media asset navigation interface from which media assets can be selected for display at the client device;
determine one or more groups of related media assets, each group of related media assets being represented for user selection from the media asset navigation interface at the client device;
identify a visual element for each group of related media assets, the visual elements each providing a coherent visual representation of the related media assets in a respective group; and
the server device configured to communicate the visual elements to the client device for display of the visual elements in the media asset navigation interface, each of the visual elements being selectable to individually navigate the related media assets in the respective groups.

10. A media asset navigation system as recited in claim 9, wherein the media asset navigation service is further configured to relate the media assets in a group of related media assets by at least one of,
a genre of the related media assets in the group;
a visual feature that is common to the related media assets in the group; or
an archetype that correlates to the related media assets in the group.

11. A media asset navigation system as recited in claim 9, wherein the media asset navigation service is further configured to identify the visual element for a group of related media assets as at least one of an image that corresponds to one of the related media assets, or a composite image that corresponds to more than one of the related media assets.

12. A media asset navigation system as recited in claim 9, wherein the media asset navigation service is further configured to identify the visual element for a group of related media assets as at least one of a video, an image, a logo, or a non-textual representation of the related media assets.

13. A media asset navigation system as recited in claim 12, wherein the media asset navigation service is further configured to initiate changes to the visual element for resolution degradation from the video to the image and then from the image to the logo as additional content navigation inputs are received that broaden the coherent visual representation of the related media assets.

14. A media asset navigation system as recited in claim 9, wherein the media asset navigation service is further configured to identify the visual element for a group of related media assets as the visual element that is most likely discernable by a user as the coherent visual representation of the group of related media assets.

15. A media asset navigation system as recited in claim 9, wherein the media assets include global media assets maintained at the server device and include local media assets maintained at the client device, and wherein the media assets include at least one of live television programs, recorded videos, music files, photographs, or documents.

16. Computer-readable media having stored thereon computer-executable instructions that, when executed by a client device that includes at least a processor, initiate the client device to:
determine one or more groups of related media assets, each group of related media assets being represented for user selection from a media asset navigation interface;
identify a visual element for each group of related media assets, the visual elements each providing a coherent visual representation of the related media assets in a respective group; and
initiate a display of the visual elements in the media asset navigation interface, each of the visual elements being selectable to individually navigate the related media assets in the respective groups.

17. Computer-readable media as recited in claim 16, wherein the computer-executable instructions, when executed, further initiate the client device to determine the one or more groups of related media assets from global media assets maintained at a server device and local media assets maintained at the client device.

18. Computer-readable media as recited in claim 16, wherein the computer-executable instructions, when executed, further initiate the client device to identify the visual element for a group of related media assets as at least one of an image that corresponds to one of the related media assets, or a composite image that corresponds to more than one of the related media assets.

19. Computer-readable media as recited in claim 16, wherein the computer-executable instructions, when executed, further initiate the client device to identify the visual element for a group of related media assets as a non-textual representation of the related media assets.

20. Computer-readable media as recited in claim 16, wherein the computer-executable instructions, when executed, further initiate the client device to identify the visual element for a group of related media assets as the visual element that is most likely discernable by a user as the coherent visual representation of the group of related media assets.
